(19) United States
(12) Patent Application Publication
(10) Pub. No.: US 2008/0296400 A1
(43) Pub. Date: Dec. 4, 2008

(54) Quantitative aerosol generator (QAG) method and apparatus

(76) Inventors: John Arthur Cooper, Beaverton, OR (US); Douglas Coleman Barth, Tigard, OR (US); Bruce Edward Johnsen, Tigard, OR (US); Michael Patrick Nakanishi, Happy Valley, OR (US); Krag Allen Patterson, Portland, OR (US); Catherine Anne Yanca, Portland, OR (US)

Correspondence Address: Goff Patent Law, 8000 NE PARKWAY DR., Suite 200, VANCOUVER, WA, 98662, US

(21) Appl. No.: 11/183,244

(22) Filed: Jul. 14, 2005

Related U.S. Application Data
(60) Provisional application No. 60/643,799, filed on Jan. 14, 2005.

(51) Int. Cl. B05B 1/24; B05B 17/04

(52) U.S. Cl. 239/11; 239/135

(57) ABSTRACT

An apparatus and method for generating an aerosol wherein the aerosol has a known concentration of metals or other chemical components, and wherein the aerosol concentration remains constant over a long period of time, rendering the apparatus and method suitable for application as a reference standard

### CROSS-REFERENCE TO RELATED APPLICATIONS

This application is a Continuation-in-Part of U.S. Provisional Application No. 60/463,799, filed Jan. 14, 2005.

### BACKGROUND OF THE INVENTION

1. Technical Field

This invention relates to a Quantitative Aerosol Generator method and apparatus.

2. Background of the Invention

In order to monitor emissions from a stack, a continuous emissions monitoring system is often used. Emissions must be monitored to demonstrate compliance with emissions standards. It would be useful to be able to generate an aerosol with a known concentration that can be used to verify the accuracy and precision of continuous emissions monitoring systems.

### BRIEF SUMMARY OF THE INVENTION

This invention is directed to an apparatus and method for producing a continuous aerosol stream having a known concentration of aerosolized metals. The apparatus and methods of this invention can be used to evaluate the bias, precision, and linearity of sampling approaches used to test the concentration of metals in stack gas emissions at hazardous waste incinerators, for example, and provides a much improved alternative to current reference methods.

An object of the invention is to provide an apparatus and method for generating an aerosol wherein the aerosol has a known concentration of metals or other chemical components.

Another object of the invention is to provide an apparatus and method for generating an aerosol wherein the aerosol has a desired droplet size.

A still further object of the invention is to provide an apparatus and method for continuous analysis of a liquid containing one or more chemical components of interest wherein the liquid is continually passed through the apparatus.

The above objects are accomplished with a quantitative aerosol generator (QAG) apparatus comprising a nebulizer, a droplet-size selector and a drying chamber.

The above objects are accomplished with a method that comprises passing the liquid of interest through a nebulizer to create liquid droplets, passing the liquid droplets through a droplet-size selector and then drying the selected droplets in a drying chamber.

In one embodiment, the QAG generates an aerosol with a known concentration of a desired analyte by using a solution wherein the analyte concentration is known. In this embodiment, the solution is provided to the QAG from a large reservoir.

In an alternate embodiment, the QAG generates an aerosol with an unknown concentration by using a solution with an unknown concentration. The unknown concentration can then be determined by using known sampling and testing techniques. In this embodiment, the solution is also provided to the QAG from a large reservoir.

In still another embodiment, the QAG generates an aerosol with an unknown concentration by using a solution with an unknown concentration, wherein the solution is continuously flowing through the QAG system, rather than being contained in a large reservoir.

### BRIEF DESCRIPTION OF THE DRAWINGS

The nature, principle and utility of the present invention will be clearly understood from the following detailed description when read in conjunction with the accompanying drawings, wherein:

FIG. 1 is a schematic view of the quantitative aerosol generator apparatus.

FIG. 2 is a more detailed schematic view of the quantitative aerosol generator depicted in FIG. 1.

FIG. 3A is a schematic view of the nebulizer shown in FIGS. 1 and 2 above.

FIG. 3B is a schematic view of the nebulizer and droplet generation chamber.

FIG. 4 is a schematic view of the droplet size-selection chamber.

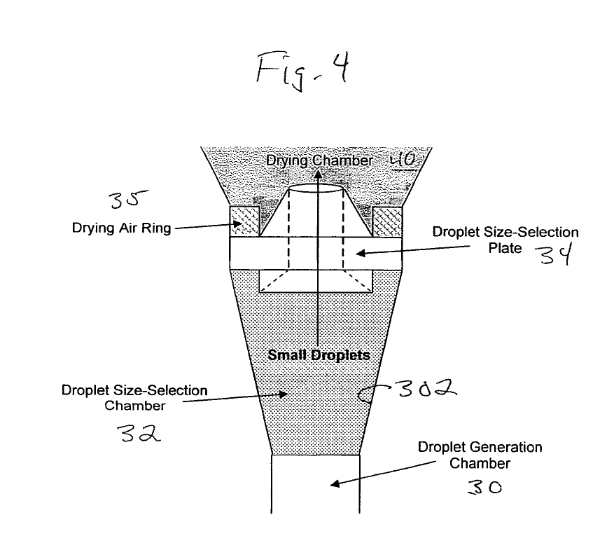

The drawings are for illustrative purposes only and are not drawn to scale. In the drawings, the same numbers are used for the same part or portion throughout the drawings.

### DETAILED DESCRIPTION OF THE INVENTION

A number of terms will be used throughout to describe the invention. Among those terms, the following are defined as follows;
Accuracy. The agreement between an experimentally determined value and an accepted reference value
Analyte. Element of interest in the analysis, e.g. As, Cd, Cr, Pb and Hg.
Analyte Line. X-ray emission line used to quantify the analyte.
Attenuation. Reduction of X-ray intensity due to energy dissipation in filter and deposit.
Calibration. The process of comparing a sampling or instrumental response with a known parametric value for the purpose of obtaining a quantitative relationship between the response and the parametric value that can be used to determine the parametric value for an unknown sample.
Detection Limit. The smallest concentration that a particular measurement can detect.
EDXRF. Energy dispersive X-ray fluorescence
EPA Practical Limits of Quantitation. The lowest level above which quantitative results may be obtained with an acceptable degree of confidence.¹⁶
Interference. An undesired positive or negative output caused by a substance other than the analyte.
Limit of Detection. Lowest concentration that can be detected by an instrument without correction for the effects of sample matrix or method-specific parameters such as sample preparation.
Limit of Quantitation. Lowest concentration that can be reliably achieved within specified limits of precision and accuracy during routine laboratory operating conditions.
NIST. National Institute of Standards and Technology.
Precision. The degree of mutual agreement between individual measurements of a parameter having the same value, namely repeatability and reproducibility.
Relative Percent Standard Deviation. The standard deviation of a set of measurements divided by the mean of the set of measurements times 100.
SRM. Standard Reference Materials.
Standard Deviation. The square root of the variance, or the precision of repeated measurements.
Standard. A value for a parameter that has been established by authority, custom, or agreement to serve as a model or rule in the measurement of quantity or the establishment of a practice or procedure.
Traceability to NIST. A documented procedure by which a measured response is related to a standard with an accuracy defined by and certified by the National Institute of Standards Technology (NIST)
Uncertainty. A statistically defined value associated with a single measurement or a value associated with a group of measurements that defines the range and probability of additional measurements falling within the defined range, and can include allowance for both systematic and random sources of error.
Unknown. A sample submitted for analysis whose elemental concentration is not known.
XRF. X-ray fluorescence.

In one embodiment of the invention an aerosolized metal is produced by a Quantitative Aerosol Generator (QAG) which uses a collision nebulizer to combine cooled and saturated air with a NIST-traceable solution of a known concentration of a metal of interest. The aerosol containing the metals is then dried and transported in an entraining air stream for analysis by XRF or other analytical methods. In one embodiment this method is useful for measuring the concentration of metals in stack gas, although the invention is not limited thereto. In one preferred embodiment the method has demonstrated applicability to the measurement of metals ranging from magnesium (Mg, atomic number 12) to uranium (U, atomic number 92) on the periodic table in a concentration ranges from five to one thousand micrograms per cubic meter (5-1000 μg/m³). The method's precision at concentrations of about 100 μg/m³ is +/− 2% with an accuracy of 5%. This represents a significant advance over known methods which are normally not able to provide a precision of less than about 20%.

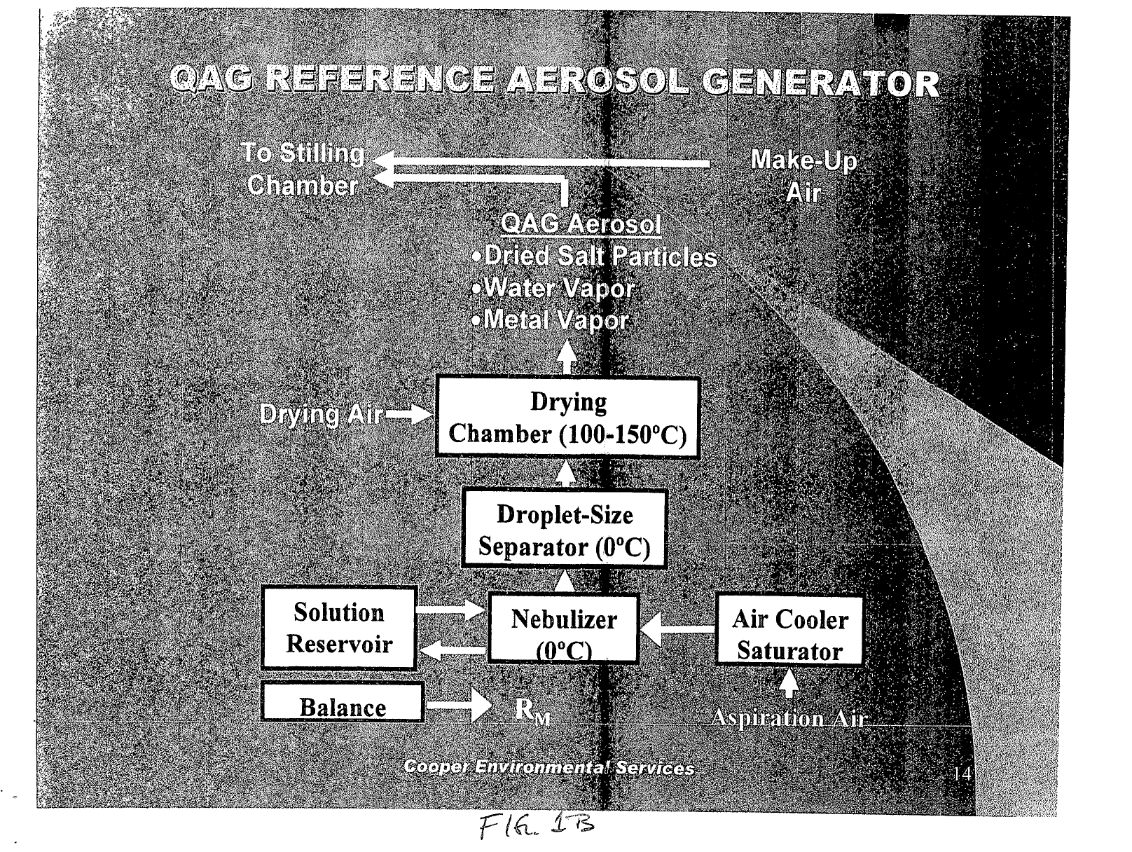

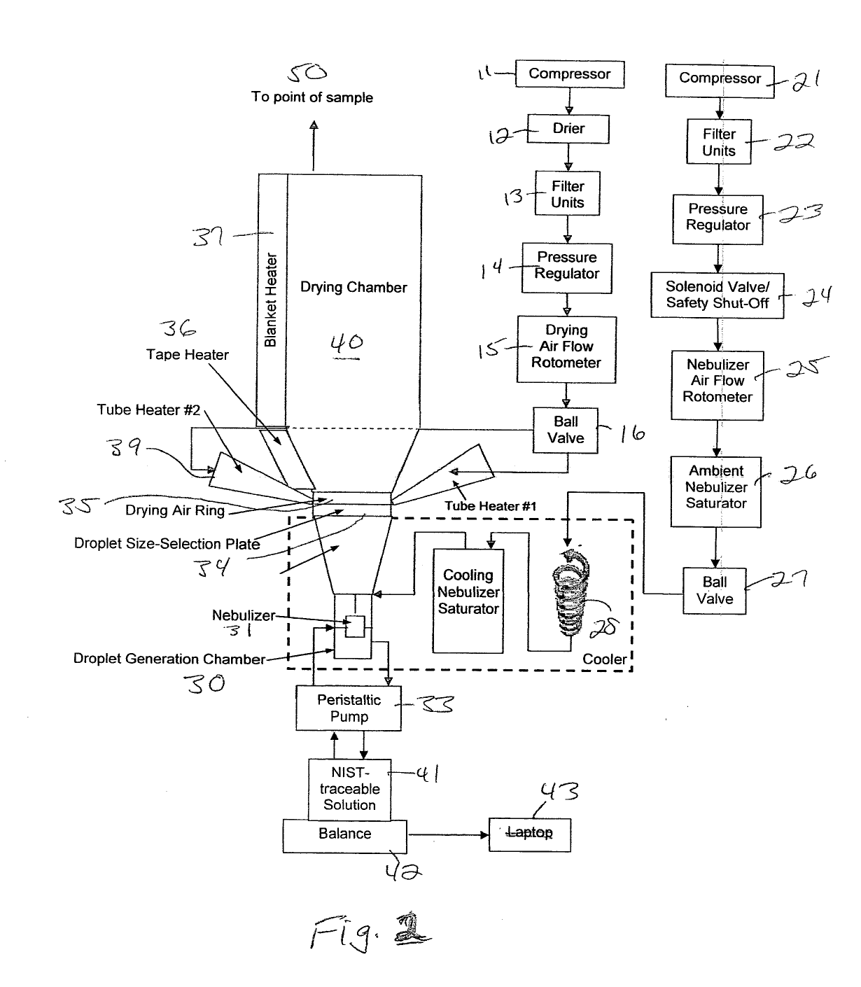

A preferred embodiment of a quantitative aerosol generator (QAG) according to the invention is described in more detail in reference to FIGS. 1 and 2. The QAG generates an aerosol from a solution containing one or more analytes. A relatively large amount of the solution is provided in a solution reservoir 41. The solution and solution reservoir 41 are placed on a balance 42. The balance 42 is used to measure the mass of the solution flowing into the nebulizer 31. A computer 43 records the changing mass of the solution in the reservoir 41. A peristaltic pump 33 circulates the solution between the droplet generation chamber 30 and the reservoir 41. The use of a relatively large solution reservoir 41 is advantageous because the relatively large amount of solution allows for only a minimal concentration change due to loss of water vapor.

The droplet generation chamber 30 and the nebulizer 31 are discussed in more detail with reference to FIG. 2. The amount of solution flowing into the droplet generation chamber 30 via inlet 202 is roughly equal to the amount of solution flowing out of the droplet generation chamber 30 via outlet 206. Therefore, depth of the solution 204 in the droplet generation chamber remains roughly constant. The solution of interest 204 is aerosolized by a collision nebulizer 31 located within the droplet generation chamber 30. Nebulizer air, which is generated by a method that will be described in greater detail below, enters the nebulizer 31 at inlet 210. The air is forced through the nebulizer 31 and out into the droplet generation chamber 30 via small holes 212 in the side of the nebulizer 31. The total flow rate of the resulting aerosol can be changed by changing the number of small holes 212 in the side of the nebulizer 31. For example, nebulizers with 1, 6 or 12 small holes may be used to achieve a desired total flow rate of the resulting aerosol. A bottom portion of the nebulizer 31 is submerged in the solution 204 and the force of the nebulizer air as it is pushed out of the holes 212 draws the solution 204 up through small holes 214 at the bottom of the nebulizer 31. The liquid spray 208 exiting the nebulizer 31 collides with the side 216 of the droplet generation chamber 30, and the force of the impact creates aerosolized liquid droplets.

The method for generating nebulizer air will be described with reference to FIG. 2. Air generated by compressor 21 is directed through filter units 22 in order to remove any undesirable contaminants, such as oil, from the air. In one preferred embodiment he QAG requires at least 20 psi and 50 slpm (2 cfm) of instrument air. Two air compressors are used to push air through the QAG in order to aerosolize the metal-containing NIST-traceable solution. The air generated by the first compressor is directed to the collision nebulizer at a rate of approximately 13 slpm. This air, hereafter referred to as “nebulizer air,” is combined with the NIST-traceable solution to create the aerosolized metals. The air generated by the second compressor, hereafter referred to as “drying air,” is used to help dry the aerosolized metals and is directed into drying chamber at a rate of approximately 34 slpm. The drying air is actively dried with a refrigerated compressed air dryer such as those manufactured by Speedair.

A pressure regulator 23 is used to control the pressure of the nebulizer air flowing into the QAG system. A solenoid valve 24 serves as a safety shut-off switch, so that the QAG can be shut down if the flow rate of the main exhaust drops below a given set point. A rotometer 25 measures the flowrate of the nebulizer air. The air saturator 26 is a bubbler containing distilled water. The nebulizer air is diffused into the water through a small filter and the air leaving the air saturator 26 is saturated at room temperature. A ball valve 27 is used as a shut-off valve for the nebulizer air. The nebulizer air is then passed through a cooler 28 containing an ice bath in order to cool the nebulizer air to 32° F. Although not depicted here, a cooling nebulizer saturator 29, droplet generation chamber 30, nebulizer 31, and droplet size-selection chamber 32 are all housed within the cooler 28.

Following the cooler 28, the nebulizer air is passed through the cooling nebulizer saturator 29, which saturates the nebulizer air at 32° F. The cooling nebulizer saturator 29 is similar to air saturator 26. The cold, saturated nebulizer air then flows to the nebulizer 31 through inlet 210, as described above with reference to FIG. 2. It is preferable that the nebulizer air be cold and saturated in order to allow for accurate calculation of the loss of water vapor.

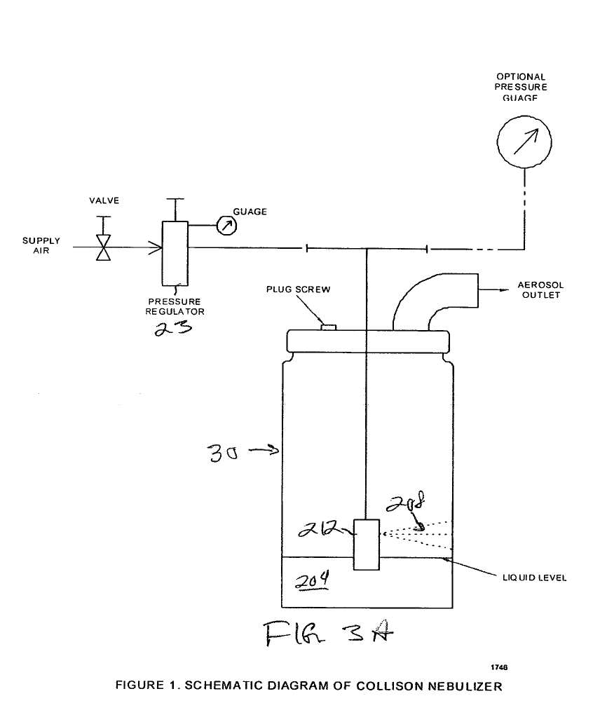

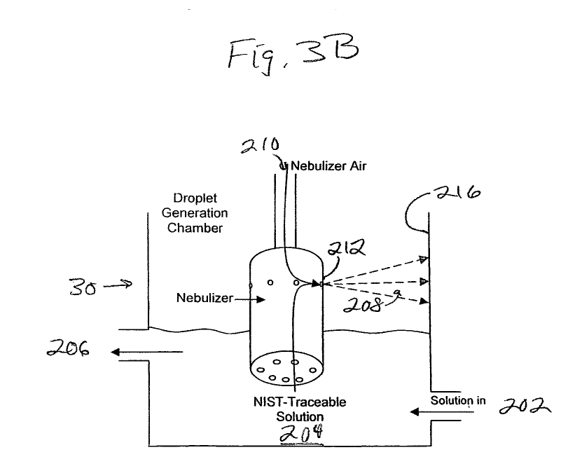

After collision against the chamber wall 216, the aerosolized liquid droplets pass out of the droplet generation chamber 30 and into the droplet size-selection chamber 32. The droplet size-selection chamber 32 is shown in more detail in FIG. 3. In the droplet size-selection chamber 32, small droplets of aerosol pass through the droplet size-selection plate 34 and into the drying chamber 40. The droplet size-selection plate is designed to allow only small droplets to pass through into the drying chamber 40. The plate consists of a PTFE gasket and PTFE funneling piece. Large droplets impact the side 302 of the chamber 32, impact the droplet size-selection plate 34 at the top of the chamber 32, or fall back into droplet generation chamber 30 due to a lack of force. All large droplets are recovered in the solution 204 (FIG. 2) at the bottom of the droplet generation chamber 30. The droplet size-selection chamber 32 allows control of the size of the resulting analyte particles. This prevents the generation of large particles that might be lost in the transport system and thus contribute to uncertainty in the resulting aerosol concentration. In other embodiments, the droplet size-selection chamber 32 may use cyclonic or plate impaction.

Drying air, which is described is greater detail below, and nebulized liquid droplets are combined in the drying chamber 40, which is heated to approximately 250° F. The droplets are dried in the chamber 40 and the resulting aerosol is then transported from the chamber 40 to a sampler via outlet 50. The drying chamber 40 is heated by a tape heater 36 and a blanket heater 37 (FIG. 1). A temperature controller maintains the temperature of the heaters at approximately 250° F.

The method for generating the drying air will be described in more detail with reference to FIG. 1. The air generated by compressor 11 is directed through a drier 12, where the air is actively dried with a refrigerated compressed air dryer. The drying air then passes through filter units 13 in order to remove any undesirable contaminants, such as oil, from the drying air. A pressure regulator 14 controls the flowrate of the drying air, which is measured by a rotometer 15. A ball valve 16 is used as a shut-off valve for the drying air. The drying air is then split into two lines downstream of the drying air ball valve 16 and each line is passed through a tube heater 39 just before the air enters the drying chamber 40. The tube heaters 39 are preferably maintained at 300° F. by temperature controllers. After being heated by the tube heaters 39, the drying air enters the drying chamber 40 through the drying air ring 35. The drying air ring 35 is located just above the droplet size-selection plate 34, and the air enters the drying chamber 40 through a series of holes in the ring. The air increases the drying rate of atomized droplets and acts as a sheath that keeps the droplets from hitting the chamber walls.

The drying air, nebulizer air, and the solution flow from their sources to the other QAG components via PFA and stainless steel tubing. All of the saturators, chambers, and the nebulizer used in the QAG are stainless steel. The saturators are lined with PFA to prevent corrosion. The drying chamber and some of the post-drying chamber transport components are insulated with 1″ thick fiber glass. Any parts that come into contact with the drying air, nebulizer air, solution, and the aerosol are corrosion resistant.

In a first embodiment, the QAG described above generates an aerosol with a known concentration of a desired analyte. In this embodiment, the solution in the reservoir 41 has a known concentration. The concentration of the aerosol can then be calculated as follows:

$${C}_{N} = \frac{( {W}_{i} - {W}_{f} ) {C}_{s} E}{V} \qquad Equation 1$$

where

C_{N}=aerosol concentration

Wᵢ=initial weight of the reference solution reservoir (before pump 33 is turned on)

W_{f}=final weight of the reference solution reservoir (after pump 33 is turned on and equilibrium is reached)

Cₛ=concentration of the analyte in the solution

E=aerosol generation and transport efficiency

V=volume of nebulizer air and drying air

The aerosol generation and transport efficiency can be calculated as follows:

E=Mₜ/(Wᵢ−W_{f})Cₛ Equation 2

where

Mₜ=the total mass collected when the QAG-generated and transported aerosol is sampled at the QAG outlet 50

An aerosol with a known concentration is useful for several applications, including verifying the accuracy and precision of a sampling method. For example, an aerosol with a known concentration can be used to verify the accuracy and precision of a continuous emissions monitoring system.

In a second embodiment, the QAG generates an aerosol with an unknown concentration of an analyte. In this embodiment, the solution in the reservoir 41 has an unknown concentration. Using a known sampling method, the concentration of the aerosol can be determined and the concentration of the solution can be calculated using the above equations.

A third embodiment is similar to the second embodiment, except that the solution with an unknown concentration is not contained in a reservoir. The solution is continuously flowing through the QAG system via the inlet 202 and outlet 206 in the droplet generation chamber 30 (see FIG. 2). This embodiment has several applications, including continuous monitor of species in such solutions as drinking water or process effluents. In this embodiment, the pump 33, reservoir 41, balance 42 and computer 43 are eliminated from the QAG system.

The QAG optionally comprises an aerosol form modifier (not shown) at the outlet 50 of the QAG. The form modifier treats the resulting aerosol with conditioners to modify the resulting aerosol. For example, catalysts or combustion chambers could be introduced down stream of the QAG to impart different characteristics to the aerosol or other aerosols, gases or vapors could be blended down stream of the QAG. For example, the addition of an alternative flow pattern down stream of the QAG could direct the QAG generated aerosol through a catalyst that might convert a mercuric chloride aerosol or a mercuric nitrate aerosol from its ionic form to its elemental form to evaluate the performance of mercury measurement instruments and their response to different forms of mercury.

The particle size of the aerosol generated by the QAG can be adjusted by adjusting the parameters of the droplet-size selection chamber 32. Additionally, the particle size can be adjusted by adjusting the solution concentrations. Because of the potential to control the particle size of the aerosol, it is possible to use the QAG for particle size and transport studies as well as other research projects.

The QAG may additionally be applicable in areas such as inorganic or organic analytes, aqueous or non-aqueous solutions and generation of aerosols of varying particle sizes.

While the invention has been described by reference to the preferred embodiments described above those skilled in the art will recognize that the invention as described and illustrated can be modified in arrangement and detail without departing from the scope of the invention.

What is claimed is:

1. An aerosol generating apparatus comprising:
a source of a liquid containing a component to be analyzed;
a nebulizer including an aerosol generator adapted for receiving a flow of the liquid and a flow of transport fluid, and generating an aerosol flow containing droplets of the liquid entrained in the transport fluid;
a droplet selection chamber in communication with the nebulizer and receiving the aerosol flow therefrom; and,
a drying chamber in communication with the droplet selection chamber for receiving the flow of fluid therefrom, and including a heater adapted for heating and drying the aerosol flow.

2. The apparatus of claim 1 wherein the aerosol generator comprises an impact-type aerosol generator.

3. The apparatus of claim 1 wherein the aerosol generator comprises an ultrasonic aerosol generator.

4. The apparatus of claim 1, wherein the source of liquid comprises a reservoir of liquid having a sufficiently large volume that the concentration of component in the liquid remains essentially constant as liquid is volatilized in the nebulizer.

5. The apparatus of claim 1, wherein the nebulizer comprises an inlet through which the transport fluid enters the nebulizer.

6. The apparatus of claim 1, wherein the transport fluid is saturated with water vapor.

7. The apparatus of claim 1, wherein the transport fluid is cooled to 0 degrees Celsius.

8. The apparatus of claim 1, wherein the droplet size-selection chamber comprises a droplet size-selection plate having at least one opening selected to reject droplets having at least a predetermined diameter.

9. The apparatus of claim 1, wherein the drying chamber comprises a drying air ring through which drying air enters the drying chamber.

9. A method for generating an aerosol, comprising:
providing a solution including a component therein;
nebulizing the solution to form a plurality of liquid droplets containing the component;
passing the liquid droplets through a droplet size-selection chamber; and
drying a first portion of the liquid droplets in a drying chamber to evaporate the liquid therefrom.

12. The method of claim 11, wherein the step of providing the solution comprises continuously flowing the solution into a droplet generation chamber while continuously flowing the solution out of the droplet generation chamber, such that a depth of the solution in the droplet generation chamber does not change substantially.

13. The method of claim 11, wherein the step of nebulizing the solution comprises:
flowing the solution into a first inlet in a nebulizer;
flowing nebulizer air into a second inlet in the nebulizer; and
creating the plurality of liquid droplets, wherein the plurality of liquid droplets exit the nebulizer through at least one outlet.

14. The method of claim 13, wherein the nebulizer air is cold and saturated.

15. The method of claim 12, wherein during the step of passing the liquid droplets through a droplet size-selection chamber, the first portion of the liquid droplets passes through the droplet size-selection chamber and into the drying chamber, while a second portion of the plurality of liquid droplets does not pass through the droplet size-selection chamber and the second portion is recycled back into the droplet generation chamber.

16. The method of claim 15, wherein the first portion of the liquid droplets are below a desired size and the second portion of the liquid droplets are above the desired size.

17. The method of claim 11, wherein during the step of drying the first portion of the liquid droplets, drying air is combined with the first portion of the liquid droplets.

18. The method of claim 12, wherein a nebulizer is disposed in the droplet generation chamber and a first portion of the nebulizer is submerged in the solution.

19. The method of claim 11, wherein the droplet size-selection chamber comprises a droplet size-selection plate.

20. The method of claim 17, wherein the drying air is heated.

21. The method of claim 11, wherein the drying chamber is heated.

22. The method of claim 12, wherein a pump is used to flow the solution into and out of the droplet generation chamber.

23. The method of claim 22, wherein the solution is pumped between a solution reservoir and the droplet generation chamber.
